(19) United States
(12) Patent Application Publication
(10) Pub. No.: US 2010/0092630 A1
(43) Pub. Date: Apr. 15, 2010

(54) METHOD FOR THE PREPARATION AND DISTRIBUTION OF BREADED SEAFOOD PRODUCTS AND BREADING COMPOSITION

(75) Inventor: Anthony Karo, Boca Raton, FL (US)

Correspondence Address: HAHN LOESER & PARKS, LLP, One GOJO Plaza, Suite 300, AKRON, OH, 44311-1076, US

(73) Assignee: SUPER FISH, INC., Boca Raton, FL (US)

(21) Appl. No.: 12/525,839

(22) PCT Filed: Jul. 31, 2009
(86) PCT No.: PCT/US09/52355

§ 371 Date: Aug. 5, 2009

Related U.S. Application Data
(63) Continuation-in-part of application No. 11/862,348, filed on Sep. 27, 2007.
(60) Provisional application No. 60/953,532, filed on Aug. 2, 2007.

(51) Int. Cl. A23L 1/325; A23L 1/01; A23P 1/08

(52) U.S. Cl. 426/293

(57) ABSTRACT

A method for preparing and frying untreated seafood in an automated process is disclosed. In an example, a single days volume of the seafood products are coated in batter, breaded in a crumb mixture comprising cracker meal and panko crumbs, refrigerated, and then fried upon placement of a customer order in a short period of time. Alternately, the refrigerated seafood product may be battered and breaded and then fried upon placement of a customer order in a short period of time, for immediate consumption. The methods allow for effective production of seafood products in the quick service restaurant type environment. The invention also relates to a method of making and distributing fried seafood products to a consumer.

### CROSS-REFERENCE TO RELATED APPLICATIONS/INCORPORATION BY REFERENCE

This U.S. patent application claims priority to and the benefit of pending U.S. international patent application number PCT/US09/52355, filed on Jul. 31, 2009. This patent application also claims priority to and the benefit of pending U.S. patent application Ser. No. 11/862,348, filed on Sep. 27, 2007, which is a non-provisional patent application of U.S. patent application Ser. No. 60/953,532, filed on Aug. 2, 2007.

### TECHNICAL FIELD

This invention relates to fried, battered and breaded seafood products and methods of making and distributing fully cooked products in a quick service environment. More specifically, this invention relates to the production of fried, battered and breaded, seafood products, which are able to be conveniently produced for use in a quick service environment. The prepared products are able to be fully cooked in significantly less time than prior products. The invention also relates to a method for preparing and frying breaded, thawed seafood. More particularly, the present disclosure relates to methods for breading and frying untreated seafood that can be fully cooked in a predetermined short period of time. The methods of the present invention also relate to the process of preparing, cooking and distributing/selling fresh or thawed seafood products in a quick service outlet.

### BACKGROUND OF THE INVENTION

The culture of many countries is moving toward a fast-food culture, with a myriad of restaurants catering to the time demands of the busy consumer. Typical fast-food or quick service restaurants prepare food products for distribution in a quick manner, and may provide for distribution via a drive through window or retail counter. In order to satisfy customer demands, the serving time from such establishments is desired to be as quick as possible, while still providing food products that are desirable to the consumer. Many such products are cooked after being ordered by the consumer, and the cooking time must therefore be as short as possible to satisfy the desires of the consumer. Attempts have been made to prepare and offer seafood products, including fried seafood products, at the time of a customer's order in a similar fashion. These prior attempts to offer seafood products via a quick service facility have not been generally successful, as the time to fully cook such seafood products has been too long. Further, the quality of the prepared seafood was not commensurate with the consumer's expectations or desires. In such quick service environments, a reason seafood products have not been successfully offered relates to the long cooking times associated with frozen products that are subsequently fried at the site of the quick service establishment. The nature of the seafood products themselves, being treated, as well as the approach for preparing and cooking such products results in a deficient product because of taste and texture, that does not meet the expectations and desires of the consumer.

Generally, the frozen, batter and breaded seafood product is stored at the quick service facility in the frozen condition, and simply removed from frozen storage to be immediately fried until the seafood is fully cooked. Alternatively, the frozen seafood product is pre-prepared in a cooked condition, and frozen for storage and subsequent reheating. In both cases, in that the products are frozen, the frozen nature of the product makes it difficult to prepare for consumption in a short period of time. Thus, the cooking time associated with such products is too long, and may range from four to seven minutes.

It has further previously been thought that for the quick service environment, it is not possible to perform the preparation of the seafood products relating to the battering and breading of the seafood products at the restaurant itself in volume, or near the time of a customer order, as this requires a quick service restaurant to expend preparation time. If the seafood product is not frozen, a further problem results from the degradation of the products prior to frying, which typically relate to the breading material becoming soggy, which in turn results in an undesirable fried product. As indicated, depending upon the requested seafood item and what the coating composition or thickness is, and whether the seafood is frozen, the cooking time may range from four to seven minutes.

Another problem with past approaches to offering seafood products in a quick service environment relates to the cooking process of frying the battered and breaded products. For producing the desired quality of products, the frying time has been too long for quick service applications, as the introduction of the frozen seafood products into the frying oil have resulted in significantly decreasing the temperature of the cooking oil, thereby lengthening the time needed to fully cook the product and produce the desired crispness and desired taste and texture in the breading material, and browning characteristics. In addition, the temperature of the cooking oil is adversely affected by the high water content in the seafood products, the amount of chemicals, preservatives and salt that may have been added, the coating composition or thickness, or other factors. This high water content also results in significant splattering and other undesirable characteristics when the seafood products are introduced into the frying oil, and will cause faster degradation of the frying oil. The introduction of other chemicals or additives into seafood products also results in an undesirable final product, and adversely affects the cooking process as well as the taste and natural texture of the seafood product.

A need therefore exists for a seafood product and method of preparing and frying seafood products that allows for fully cooking the seafood in a predetermined, short period of time. There is also a need for a method or approach to allow seafood products to be effectively prepared and distributed in a quick service restaurant facility.

### SUMMARY OF THE INVENTION

Based upon the foregoing, the present invention is in one aspect directed to a method for preparing seafood which overcomes the problems noted in the prior art. The method comprises the steps of obtaining a quantity of uncooked, untreated, fresh or thawed seafood, and selectively preparing a single days amount of the seafood product for cooking and distribution to a consumer on the same day. The preparation of the seafood products include coating the products with a batter, and breading the coated seafood with a predetermined breading composition. The single days amount of battered and breaded seafood products are then stored in a predetermined refrigerated environment, particularly at a temperature between about 38° F. to about 45° F. Upon receiving an order for the seafood product, the refrigerated battered and breaded seafood product is then prepared for distribution by frying the breaded seafood product in a cooking oil at a predetermined temperature for a predetermined period of time until the seafood is fully cooked. Alternately, upon receiving an order, the refrigerated seafood (such as at 38° F. to about 45° F.) is battered and breaded and cooked immediately for distribution.

In a further aspect, the invention is directed to a method of distributing seafood products in a quick service restaurant environment comprising the steps of preparing a predetermined quantity of selected seafood products for use on a single day, including the steps of coating the uncooked seafood with a batter, and further coating the battered seafood product with a predetermined breading composition. The batter and breaded seafood product is refrigerated at a temperature in the range of about 38° F. to about 45° F. Upon ordering by a customer, the refrigerated seafood product is fried in a predetermined cooking oil for a predetermined amount of time, such as 120 seconds or less, or more particularly 90 seconds or less, until the seafood is fully cooked. Alternately, upon receiving an order, the refrigerated seafood (such as at 38° F. to about 45° F.) is battered and breaded and cooked immediately for distribution. The seafood products are desirably obtained as fresh or frozen product, and are processed according the above steps in a fully thawed condition. The seafood products are also desirably substantially free of additives, including water or other solutions, chemicals, preservatives or salt.

The invention also relates to a breading composition which absorbs moisture from the battered seafood product in a predetermined manner. The composition comprises a mixture of panko bread crumbs in the range of 75% to 80%, and cracker meal in the range from 20% to 25%. The breading composition enables the moisture from the battered seafood products to be absorbed without degradation of the composition to a degree so as to make it unfit for producing a fully cooked product for sale to a consumer, for a predetermined time period in the range of about 8 to 10 hours, and possibly up to 12 hours. The breading composition further functions to significantly impede the absorption of moisture into the panko crumb and the degradation of the products presentation and taste.

Other aspects of the invention will become apparent upon a further reading of the following description of an example, in conjunction with the drawing.

### BRIEF DESCRIPTION OF THE DRAWINGS

FIG. 1 shows a diagram of a method according to an example of the invention.

### DETAILED DESCRIPTION OF THE INVENTION

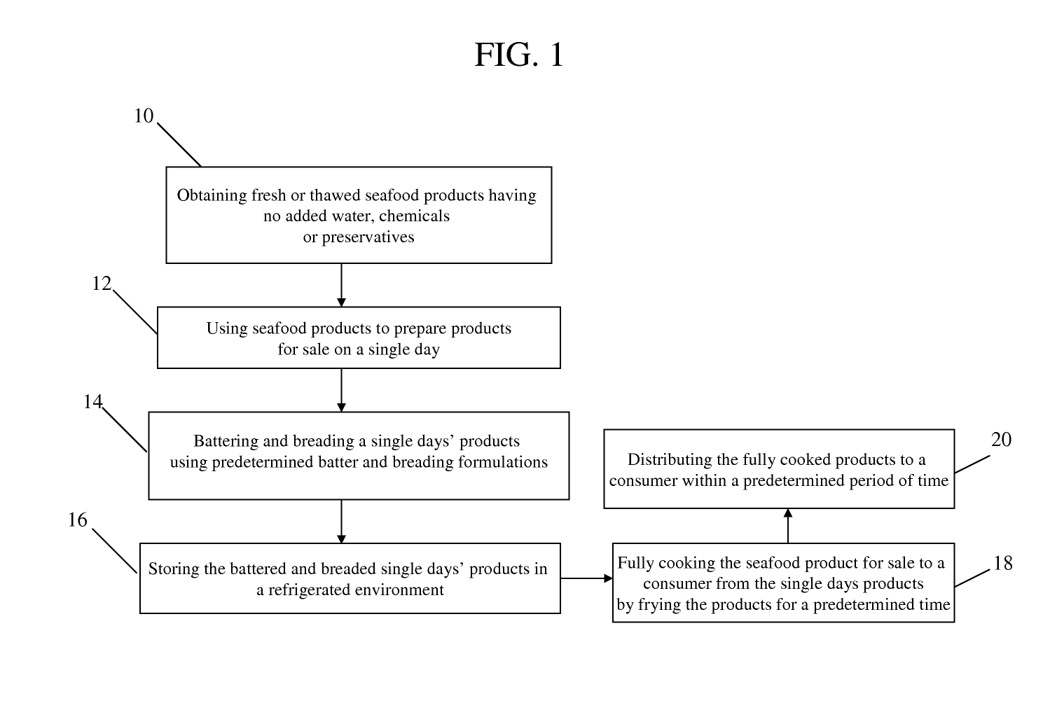

Examples of seafood that may be prepared by the disclosed methods according to the invention include, without limitation, shrimp, cod or other fish fillets, clams, oysters, scallops or a variety of other seafood products. It is also contemplated that the seafood products could be ground, minced or chopped, formed and/or extruded, such as being prepared into a patty or ball type or other form, and may include additional ingredients such as binders or the like if desired. The invention is also directed to the preparation and distribution of seafood products in a quick service environment. In the context of the invention, “quick service” may mean any environment where seafood products are prepared and distributed in the same day to a consumer, which may include quick service restaurants, military environments, governmental environments, hotels, hospitals, convenience stores, and many other environments or facilities. With reference to FIG. 1, initially, a quantity of uncooked seafood that has never been injected or otherwise treated with chemicals, preservatives, salt or other materials (“untreated”) is obtained at 10. Seafood prepared by quick service restaurants is generally injected with chemicals and/or preservatives or salt (“treated”) to increase the perceived portion size, to enhance plumpness, and to help maintain the freshness of the seafood. While this added moisture may enhance the customer perception of the food product, it may also alter the natural taste of the seafood. Additionally, the added moisture seeps out of the seafood and results in moistening of any breading or coating on the seafood product. The result is that the breading degrades significantly prior to cooking, making any product undesirable for ultimately cooking and serving to a customer. In the quick service environment, the seafood product is normally frozen to avoid such a consequence, resulting in the problems previously noted. Additionally, treated seafood may release some of the artificially added moisture when placed into the heated cooking oil. The released moisture causes a significant decrease in the temperature of the cooking oil, which results in the need for longer cooking times, and therefore, additional waiting time by consumers while their food is being cooked. Furthermore, any moisture released by the treated seafood during frying may boil upon contact with the hot oil and create steam, which is known to cause undesirable soggy breading and/or burning upon further cooking. These materials also result in faster degradation of the cooking oil. Untreated seafood according to the present invention is fully thawed and releases only natural amounts of moisture as compared to treated seafood, thereby minimizing any decrease in the cooking temperature of the cooking oil, and allowing uniform cooking of the entire product.

After the seafood has been obtained, an amount of prepared seafood products are produced for sale on a single day at 12. As will be hereinafter described, the seafood products are prepared in a manner that they are perishable after a predetermined time period. As the products are perishable, only a single days worth of product is prepared. In the quick service restaurant operation, the products may be prepared before customers begin ordering products for consumption, such as in the morning. Alternately, the refrigerated seafood may be prepared upon receiving an order, wherein the refrigerated seafood (such as at 38° F. to about 45° F.) is battered and breaded and cooked upon receiving a customer's order, for immediate distribution. Preparation of the seafood products includes battering and breading the products in a batter and breading composition having predetermined characteristics, at 14. After the appropriate preparation of the seafood product to be served, such as cutting to size, washing, thermal tempering, etc., the product is coated with a conventional liquid batter, such as a batter designed for the subsequent application of a breading composition. The batter is applied by conventional batter application equipment which may include curtain/waterfall/cascade application or tempura/submersion/immersion of the seafood products. Amounts of a batter mix and water are combined to prepare the preferred viscosity batter for application to the products, such as in a 1:1.5 ratio. The viscosity and coating of the seafood products desirably produce a coating (with crumb or breading materials) where the coating is equal to or less than 35% of the total weight of the product. A suitable batter mix is produced by Kerry Group, PLC. In an example, after the batter is prepared to the desired viscosity, the seafood is placed on a conveyor belt and passed through a batter curtain which coats the surface of the seafood with a layer of batter. The batter product may be free from added chemicals such as MSG, sodium tripolyphosphate or other chemicals. The batter may also be free of or minimally use other ingredients, such as high fructose corn syrup or other ingredients, to form a batter that is healthier and less fattening. Although a variety of batters and application equipment or processes may be used, a batter mix produced by Golden Dipt Foodservice of Beloit, Wis. has proven effective when employed in the disclosed method. In this example, the batter is applied to the seafood product using a batter applicator which is simple to use in a quick service restaurant environment. A suitable applicator is the batter/breading equipment produced by Bettcher Industries, Inc. of Birmingham, Ohio, such as the Optimax Automatic Batter-Breader equipment or SBB Batter-Breading equipment.

Following battering, the coated seafood is breaded with a breading composition mixture, which adheres to the battered surface of the seafood products. The breading composition comprises cracker meal and Japanese-style panko bread crumbs. In one embodiment, the crumb mixture comprises 80% panko bread crumbs and 20% cracker meal, although the panko content of the crumb mixture may range from 75% to 80%, while the cracker meal content of the crumb mixture may range from 20% to 25% in conjunction with the panko crumbs. Exemplar panko bread crumbs are those manufactured by Kerry Group, PLC, along with suitable cracker meal for use in the disclosed method. Both the coating and breading steps have been adequately performed using the battering/breading equipment offered by Bettcher Industries, Inc., of Birmingham, OH as noted above.

If preparing the seafood products for later cooking, after the seafood is coated and breaded, the single days amount of prepared seafood product is placed in a refrigeration device at 16 at a temperature between about 38° F. and about 45° F. The breaded seafood may be held at this temperature for a period of several minutes up to about eight to ten hours or up to twelve hours without the breading mixture becoming soggy or degrading so as not to be usable for producing a final cooked product. Prior art processes that have involved battering, breading, and then refrigerating breaded seafood have failed to maintain non-soggy breading for periods longer than about three hours. The cracker meal component of the crumb mixture employed in the breading step effectively absorbs moisture released from the seafood during the refrigeration step and prevents the panko bread crumbs from becoming soggy, which may lead to overcooked breading or breading falling off of the seafood during the frying process. In general, as the temperature at which seafood is stored increases, the amount of moisture released by the seafood increases. Therefore, storing seafood at a temperature higher than about 45° F. may result in release of moisture in quantities greater than desired, which may allow the cracker meal to absorb more moisture than desired. Alternately, the refrigerated seafood may be prepared upon receiving an order, wherein the refrigerated seafood (such as at 38° F. to about 45° F.) is battered and breaded and cooked upon receiving a customer's order, for immediate distribution.

Upon placement of an order by a customer, the requested seafood is removed from the refrigerator and immersed in hot oil for frying for a predetermined period of time at 18, or if prepared for immediate consumption, is battered and breaded and then fried for a predetermined time. The frying step in this example is performed using a hoodless/ventless frying system produced by the Perfect Fry Company of Calgary, Canada, referred to as the PFA Series. The use of a fully automatic, hoodless/ventless countertop fryer system such as this allows the quick service restaurant to implement the cooking step in a simple and cost-effective manner, without the need for expensive hood and vent systems which significantly add to the initial costs of such a facility. Such equipment also enables the quick service operator to avoid the need for permits and or other approvals required for hooded and vented frying systems. Alternatively, any suitable frying system that allows timed cooking may be used for example. The equipment may use rice, vegetable or other suitable oil heated to 375° F., and the prepared and stored seafood products are fried for approximately 30 to 90 seconds, but for some products the predetermined cooking time is contemplated to be 120 seconds or less. Upon initial immersion of the breaded seafood, the temperature of the oil will drop only approximately 10° F., which is relatively smaller than temperature drop in oil temperature experienced when frozen or moisture-injected seafood products are placed into 375° F. oil. The decreased drop in temperature experienced while practicing the disclosed method enables the seafood to cook in a shorter period of time because the oil is maintained at a higher temperature, and less time is spent returning the oil to the proper cooking temperature after initial immersion of the seafood.

After cooking, the seafood products are served to the consumer within a predetermined period of time at 20, such as within four minutes of ordering. The short cooking time enabled by the arrangement in the invention provides at least several significant benefits to the customer. First, the rapid cooking time ensures that the customer will be served their freshly made seafood in short time after ordering when compared to the typical processes which require a frying time of approximately four to seven minutes, and results in a wait time from placing an order of about ten minutes. Secondly, the short frying time ensures that the crumb mixture absorbs less oil than breaded seafoods fried for longer durations, and therefore results in a healthier food choice that traditionally breaded and fried seafood. Thirdly, the resultant product has better flavor and natural texture as it is prepared from untreated products. The use of rice oil also facilitates minimizing oil pick up by the breading composition, and has characteristics which produce a very aesthetically pleasing product having the desired mouth feel and taster. Although any oil with a smoke point greater than 375° F. may be employed in the present method, non-hydrogenated rice bran oil containing increased values of antioxidants, including oryzanol, is known to yield desired results.

The foregoing disclosure is illustrative of the present invention and is not to be construed as limiting the invention. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description and drawings illustrate the present invention, and are not to be construed as limited to the specific embodiments disclosed.

1-21. (canceled)

22. A method for preparing seafood comprising the steps of:
a. obtaining a quantity of uncooked seafood and refrigerating it at a temperature between about 38° F. and about 45° F.;
b. coating the seafood with a batter;
c. breading the coated seafood with a crumb mixture; and
d. frying the breaded seafood in a heated oil until the seafood is fully cooked, wherein the seafood is an untreated seafood.

23. A method for preparing seafood in a quick food service environment comprising:
a. obtaining a quantity of untreated seafood that is fresh or thawed;
b. coating the seafood with a batter;
c. breading the coated seafood with a crumb mixture, wherein the coating comprised of the batter and breading is equal to or less than 35% of the total weight of the seafood product;
d. refrigerating the breaded seafood at a temperature between about 38° F. and about 45° F. for a period of time; and
e. upon receiving an order for a seafood product, frying the breaded seafood in a heated oil for a period of 120 seconds or less until the seafood is fully cooked; and
f. serving the cooked seafood product.

24. The method according to claim 23, wherein the breading used is capable of absorbing moisture without significant degradation over a predetermined period of time.

25. The method according to claim 24, wherein the predetermined period of time is up to twelve hours.

26. The method according to claim 23, wherein the step of frying the coated and breaded seafood is performed at an oil temperature of approximately 375° F.

27. The method according to claim 23, wherein the frying of the coated seafood product in heated oil does not cause a significant drop in temperature due to the temperature of the seafood product, enabling the seafood product to cook in a shorter period of time due to the oil being maintained at a higher temperature, and less time incurred in returning the oil to the proper cooking temperature after initial immersion of the seafood.

28. The method according to claim 23, wherein the untreated seafood is free of added water, chemicals, preservatives and salt.

29. The method according to claim 23, wherein the frying of the coated seafood product in a heated oil is performed for a period of 90 seconds or less.

30. A method for preparing seafood for a quick food service environment comprising:
obtaining a quantity of uncooked, fresh or thawed seafood, the seafood being untreated seafood which is free of added water, chemicals, preservatives and salt, and selectively preparing a single days amount of the seafood product for subsequent cooking, the step of preparation includes coating the seafood products with a batter, and breading the coated seafood with a predetermined breading composition,
storing the single days amount of battered and breaded seafood products in a predetermined refrigerated environment, at a temperature between about 38° F. and about 45° F.,
upon receiving an order for the seafood product from a consumer, cooking the refrigerated, battered and breaded seafood product by frying the breaded seafood product in a cooking oil at a predetermined temperature for a predetermined period of time, and serving the cooked seafood product.

31. The method according to claim 30, wherein the step of frying the coated and breaded seafood is performed at an oil temperature of approximately 375° F. for a period of time less than 120 seconds.

32. The method according to claim 30, wherein the frying is performed using a hoodless/ventless frying system.

33. The method according to claim 30, wherein the storing of the coated seafood products is for a period of 12 hours or less.

34. The method according to claim 30, wherein battering and breading of the untreated seafood is performed in a machine operation.

35. The method according to claim 30, wherein battering, breading and storage of the untreated seafood is performed when in a non-frozen state.
